(19) United States
(12) Patent Application Publication
(10) Pub. No.: US 2008/0263233 A1
(43) Pub. Date: Oct. 23, 2008

(54) INTEGRATED CIRCUIT AND MEMORY DEVICE

(76) Inventors: Thomas Hein, Munich (DE); Udo Moeller, Munich (DE)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/737,322

(22) Filed: Apr. 19, 2007

(51) Int. Cl. G06F 3/00

(52) U.S. Cl. 710/12

(57) ABSTRACT

A memory device comprises a first port receiving a first register value and a second register value; a second port, receiving a third value; a first register being set to the first register value; a second register having an enabled status and a disabled status, the register being set to the second register value in the enabled status, the second register remaining unchanged in the disabled status; and a logic unit setting the status of the second register dependent on the first register value and the third value.

### BACKGROUND OF THE INVENTION

Demands imposed on large scale integrated circuits are constantly increasing. In the case of memory devices, said demands mainly translate into speed and storage capacity. As far as high speed memory devices are concerned, the computer industry has established the so-called DRAM (Dynamic Random Access Memory) as economic means for high speed and high capacity data storage. In somewhat special applications, such as graphic adaptors and graphics cards, the industry has established specialized types, such as GDRAM (Graphics Dynamic Random Access Memory) or the GDDR (Graphics Double Data Rate) memory devices.

Although a DRAM requires a continuous refreshing of the stored information, speed and information density, combined with a relatively low cost, have put the DRAM to a pivotal position in the field of information technology. Almost every modern computer system, ranging, for example, from PDAs over notebook computers and personal computers to high-end servers, take advantage of this economic and fast data storage technology. Nevertheless, there are also established alternative and/or non-volatile memory concepts, including, for example, the so-called flash-RAM, the static RAM (SRAM), the phase change RAM (PC-RAM), the conductive bridging RAM (CB-RAM), magneto-resistive RAM (MRAM), and other types of resistive and/or non-volatile RAM concepts.

While the storage capacity of modern memory devices is steadily increased, also the manufacturing costs of a modern memory device may be an important factor for its economic success. At the same time, it may be required to offer memory devices which are able to adapt to the actual application and/or to a position within an superordinated circuitry. However, in order to keep manufacturing costs at a minimum, it may be a common method to apply options at a top most possible level. Such options include storage capacity, access speed, latency timing, port width, and/or a connection layout.

As far as the latter connection layout is concerned, it may be common for a conventional integrated circuit to change and reroute a connection layout according to especially dedicated input ports. Such a change of a connection layout may include, for example, a mirroring of the connection terminals in respect to a mirror axis, in order to allow for a mounting of same-type integrated devices on a top surface and a bottom surface of a printed circuit board, while maintaining the same layout for contact pads on the printed circuit board.

### SUMMARY OF THE INVENTION

Various embodiments of the present invention may provide particular advantages for an improved memory device, an improved memory module, an improved integrated device, an improved circuit system, or an improved method of operating an integrated device.

A memory device may comprise a first port, the first port receiving a first register value and a second register value; a second port, the second port receiving a third value; a first register being coupled to the first port, the first register being set to the first register value; a second register being coupled to the first port, the register having an enabled status and a disabled status, the register being set to the second register value in the enabled status, the second register remaining unchanged in the disabled status; and a logic unit being coupled to the second port, to the first register and to the second register, the logic unit setting the status of the second register to the enabled status or the disabled status dependent on the first register value stored in the first register and the third value applied to the second port.

A memory device may comprise a first port, the first port receiving a first register value and a second register value; a second port, the second port receiving a third value; an address port receiving address data; a first register being coupled to the first port, the first register being set to the first register value; a second register being coupled to the first port; a third register being coupled to the first port; a logic unit being coupled to the second port and to the first register, the logic unit setting a register status; and an addressing unit being coupled to the address port, to the logic unit, to the second register and to the third register, the addressing unit addressing the third register to be set to the second register value dependent on an address data being applied to the address port and the register status being set by the logic unit.

A method of operating an integrated device, the integrated device comprising a first register, a second register and an input, may comprise storing a first register value in the first register; applying a signal to the port; setting a status of the second register to an enabled status or a disabled status dependent on the first register value stored in the first register and the signal applied to the input; and storing a second register value in the second register in case the enabled status is set.

A circuit system may comprise a controller, a first integrated device and a second integrated device, each integrated device comprising a first port being coupled to the controller and receiving a first register value and a second register value; a second port, the second port receiving a third value; a first register being coupled to the first port, the first register being set to the first register value; a second register being coupled to the first port, the register having an enabled status and a disabled status, the register being set to the second register value in the enabled status, the second register remaining unchanged in the disabled status; and a logic unit being coupled to the second port, to the first register and to the second register, the logic unit setting the status of the second register to the enabled status or the disabled status dependent on the first register value stored in the first register and the third value applied to the second port.

An integrated device may comprise means for storing a first register value; first means for storing a second register value in case an enabled status is set; means for receiving a signal; and means for setting the enabled status or a disabled status of the first means for storing the second register value dependent on the first register value and the signal.

### BRIEF DESCRIPTION OF THE DRAWINGS

These above recited features will become clear from the following description, taking in conjunction with the accompanying drawings. It is to be noted, however, that the accompanying drawings illustrate only typical embodiments and are, therefore, not to be considered limiting of the scope of the invention. The present invention may have equally effective embodiments.

FIGS. 1A through 1C show schematic views of integrated devices according to a first, to a second, and to a third embodiment;

FIGS. 2A and 2B show schematic views of a memory system according to a fourth embodiment;

FIG. 3 shows a schematic view of a logic unit according to a fifth embodiment;

FIG. 4A and 4B show schematic views of a memory system according to a sixth embodiment;

FIG. 5 shows a schematic view of a logic unit according to a seventh embodiment;

FIG. 6 shows a schematic view of a circuit system according to an eighth embodiment; and

FIG. 7 shows a schematic view of a memory module according to a tenth embodiment.

### DETAILED DESCRIPTION OF THE PREFERRED EMBODIMENT

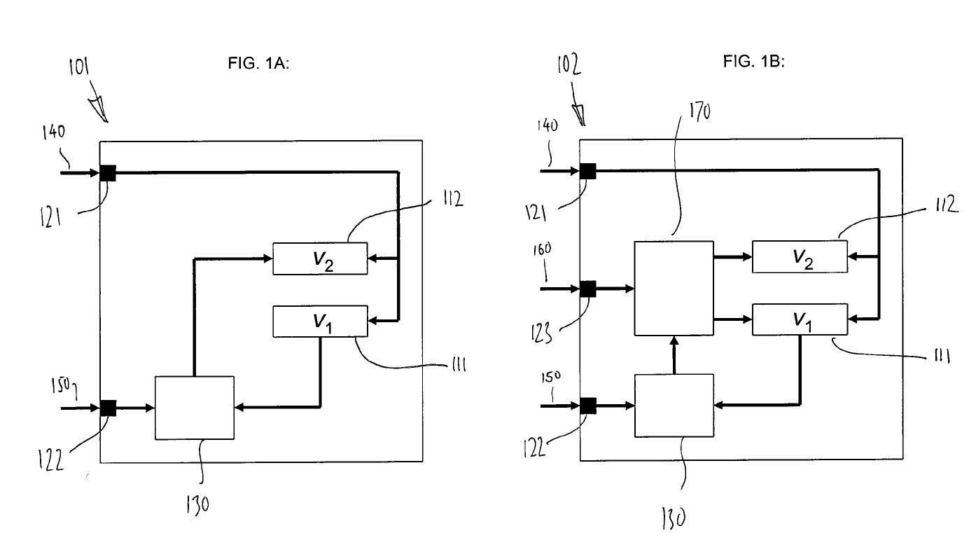

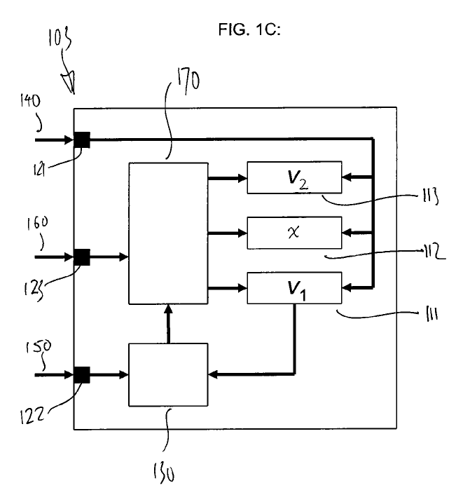

FIG. 1A shows a schematic view of an integrated device according to a first embodiment. An integrated device 101 may comprise a first port 121 and a second port 122. The integrated device 101 further comprises a first register 111 and a second register 112. Also, the integrated device 101 comprises a logic unit 130. The integrated device 101 may be or comprise, for example, a memory device, a microprocessor, a programmable logic device, a DRAM, a GDRAM, a GDDR-DRAM, a central processing unit (CPU), or a graphics processing unit (GPU).

The first port 121 receives data 140 to be written into the first register 111 and into the second register 112. In this way, a first register value v₁ or a second register value v₂ may be stored in the registers 111,112. The second port 122 receives data 150. This data 150 may comprise a signal, such as a high level signal and/or a low level signal, and/or command data, user data, and/or address data. The data 150 may comprise a mirroring signal (MF) in order to instruct the integrated device 101 such to mirror connection terminals of a terminal array in respect to a mirroring axis. This mirroring signal may be a static signal and the second port 122 may comprise an MF-pin, which may hard-wired or statically connected to a respective potential.

According to this embodiment, the first register 111 stores the first register value v₁. Furthermore, the logic unit 130 decides whether the second register value v₂, being received from the first input 121, is written into the second register 112 or not. This decision is based on the register value v₁, being stored in the first register 111, and a value, being received from the second port 122, such as a third value.

The decision may be determined in accordance to a mode of the second register 112. Such a mode may include an enabled mode and a disabled mode, wherein, in the enabled mode, the register value v₂ is stored in the second register 112, and, in the disabled mode, the contents being stored in the second register 112 may remain unchanged. The enabled mode and the disabled mode may be determined by the logic unit 130 based on the first register value v₁ and a value being received from the second port 122.

An example of a value being received from the second port 122 includes a one-bit binary number, which may assume a value “0” and “1”. Those values may correspond to a respective electric signal, which is applied to the second port 122. In this way, a low level, such as a voltage level close to the ground potential and/or below a threshold voltage, may imply a value “0”, whereas, a second electric signal, at a potential close to a supply voltage, and/or greater than the threshold voltage, may represent a “1”. Furthermore, the register value v₁ may be represented by at least one bit, two bits, or a binary number of arbitrary length. Common number lengths include 8 bits, 16 bits, 32 bits, and 64 bits. At least one of these bits may influence the decision being made by the logic unit 130. For example, the register value v₂ is written into the second register 112, if a respective bit of the first register value v₁ matches the value being received from the second port 122. If, on the other hand, these values do not match, the register value v₂ is not written into the second register 112, and the contents of the second register 112 remains unchanged. In addition, the logic unit 1390 may take into account other data, such as command and/or address data, to make the decision whether the mode of the second register 112 is to be set to “enabled” or “disabled”. While the signal to the second input 122 may be hard wired, the register value v₁ may be changed, and, hence, the behavior of writing or not writing into the second register 112 may be still subject to change.

FIG. 1B shows a schematic view of an integrated device according to a second embodiment. An integrated device 102 may comprise elements, parts, and/or entities of the integrated device 101 as they have been described in conjunction with FIG. 1A. Hence, reference is made here to the elements, parts and/or entities wearing corresponding reference numbers. According to this embodiment, the integrated device 102 comprises a third input 123 and an addressing unit 170. The addressing unit 170 receives address data 160 from the third input 123. Furthermore, the addressing unit 170 is coupled to the logic unit 130. The addressing unit 170 is further coupled to the first register 111 and the second register 112 and determines which of the connected registers 111, 112 is to be written to, depending on the address data being received from the address port 123. A register value, such as the first register value v₁ and the second register value v₂, are received from the first port 121 by means of data 140. The addressing unit 170 addresses the second register 112 upon receiving corresponding address data if it is instructed so by the logic unit 130.

In this way, data 140 and address data 160 may be applied to the first port 121 and to the third port 123 for writing a second register value v₂ into the second register 112. According to this embodiment, the integrated device 102 executes such a writing command only if the logic unit 130 decides so. For this purpose, the logic unit 130 may evaluate the register value v₁ or a part of the register value v₁, being stored in the first register 111 and a value being received from the second input 122, by means of the signal 150. In this way, two same-type integrated devices 102 may be connected in parallel, with the exclusion of different signals being applied to second ports 122, while still allowing for a parallel writing of a register value v₂ into both second registers and/or a distinguished writing of different register values v₂ into the two second registers 122, dependent on the first register value v₁ and the register value being received from the second port 122. While the signal to the second input 122 may be hard wired, the register value v₁ may be changed, and, hence, the behavior of writing or not writing into the second register 112 may be still subject to change.

FIG. 1C shows a schematic view of an integrated device according to a third embodiment. An integrated device 103 may comprise elements, parts, and/or entities of the integrated device 101 and/or the integrated device 102 as they have been described in conjunction with FIGS. 1A and 1B. Hence, reference is made here to the elements, parts and/or entities wearing corresponding reference numbers.

According to this embodiment the integrated device 103 comprises a third register 113. The third register 113 may store a register value, such as the second register value v₂. The addressing unit 170 may re-route a register value v₂ into the third register 113, even if the corresponding address data 160, being received from the third input 123, addresses the second register 112. This decision, whether to use a received address or to alter, re-map, or re-address the received address, may be made according to an input from the logic unit 130. Re-routing may be effected by means of increasing or decreasing, for example by means of adding or discounting a given address off-set, the received address, or a by means of re-mapping using a remapping table.

In this way, the logic unit 130 may decide, taking into account the register value v₁ being stored in the first register 111 and a value being received from the second input 122, whether a value is written to a register being addressed by the address data 160, such as the second register 112, or to another register, such as the third register 113. In the case that the addressing unit 170 re-routes the second register value v₂, having a corresponding address of the second register 112, to the third register 113, the second register value v₂ is written into third register 113, whereas the register value being stored in the second register 112 may remain unchanged, indicated by x.

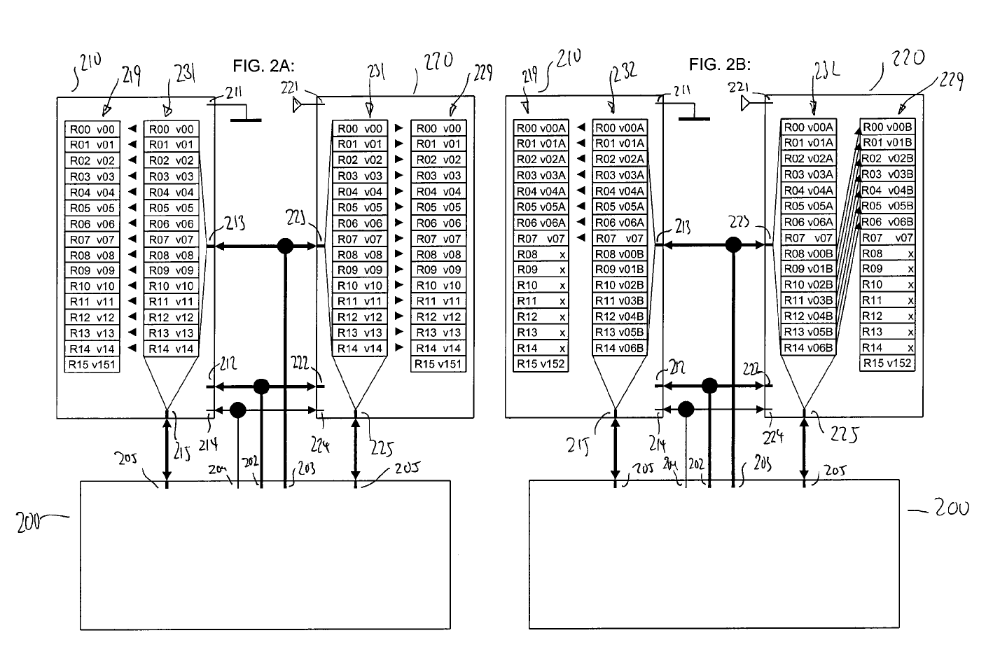

FIG. 2A and 2B show a memory system, according to a fourth embodiment. The memory system comprises a first memory device 210, a second memory device 220, and a controller 200. The memory devices 210, 220 may be, for example, DRAMs, GDRAMs, or GDDR DRAMs. The controller 200 may be, for example, a memory controller, a central processing unit, a microprocessor, or a graphics controller. The memory device 210 is connected via a data port 215 to a data port 205 of the controller 200. In a corresponding manner, the second memory device 220 is connected via a data port 225 to a data port 205 of the controller 200. The controller 200 may also comprise a single data port, to which both devices 210, 220 may be then connected in parallel. A command port 212 of the first memory device 210 and a command port 222 of the second memory device 220 are connected in parallel to a command port 202 of the controller 200. An address port 213 of the first memory device 210 and an address port 223 of the second memory device 220 are connected in parallel to an address port 203 of the controller 200.

In addition, a select port 214 of the first memory device 210 and a select port 224 of the second memory device 220 are connected in parallel to a select port 204 of the controller 200. In this way, the controller 200 selects or deselects both memory devices, the first memory device 210 and the second memory device 220, simultaneously. The select signal being transmitted by the controller 200 via its select port 204 and being received by the select inputs 210 and 224 of the memory devices 210, 220 may comprise a conventional select signal, such as a chip select signal (CS). Furthermore, the first memory device 210 comprises an input port 211, and the second memory device 220 comprises an input 221, for receiving a signal.

According to this embodiment, the input ports 211 and 221 receive different signals, such as a ground signal and/or a supply voltage signal. Pairs of different signals may include any pair of distinguishable signals, such as ground/VDD, high level/low level, or potential below a threshold voltage/potential above a threshold voltage. Furthermore the input ports 222, 221 may be hard-wired to the respective signal source, for example, by soldering the respective contact terminal of the first memory device 210 to a ground line or GND, and the respective contact terminal of the second memory device 220 to a supply line or VDD. The input ports 211, 221 may further comprise a mirroring input, which may instruct a mirroring unit of an integrated device 210, 220 such to mirror connection terminals of a terminal array, for example, in respect to a mirroring axis.

The first memory device 210 comprises a set of registers 219, here, as an example, comprising registers R0 through R15. The second memory device 220 correspondingly comprises a set of registers 229, here, as an example, comprising registers R0 through R15. A register Rn, n ranging here from 00 through 15, may be accessible through an address Rn and may store a register value vn, ranging here from v00 through v14.

In the situation as shown in FIG. 2A, the registers R15 of both memory devices 210, 220 may store a first register value v151. A register, such as R15, may also control a training of address timing of the memory devices 210, 220, and may, thus, store a partial value of the register value being stored in it, such to execute other purposes. The memory devices 210, 220 may receive a first data set 231 via their respective data ports 215, 225 and address ports 213, 223. The first data set 231 may comprise register values v00 through v14 to be stored in the registers at addresses R00 through R15. According to this situation and embodiment, the register value 151 is such that both memory devices 210, 220, regardless of the value or signal being received from the input port 211, 221, write data vn addressed to Rn into the nth register Rn of the set of registers 219, 229. For example, the first memory device 210 and the second memory device 220 write a register value v00 being addressed to R00 into their R00-registers, v01 to their R01 registers, and so forth. Making the decision according to this situation may be effected by means of a logic unit according to an embodiment as they are described in conjunction with FIGS. 1A through, 1C, 3, or 5.

In this way, the controller 200 writes identical register values into the registers of both memory devices, the memory device 210 and the memory device 220. This may require only a single writing sequence for each register of both memory devices, since both memory devices are selected simultaneously. A separate selecting of the individual devices 210, 220, which may require separate select signal lines, may hence be rendered obsolete.

It may be provided, for an example, that the registers R15 of both memory devices 210, 220 are always enabled or accessible, in order to render it possible to reliably write into registers R15 of both memory devices, the first memory device 210 and the second memory device 220, regardless of the register value v151 and/or a value or signal being received from the input port 211, 221. The register R15 may further be a common mode register used by a controller to write identical data into all connected memory devices.

FIG. 2B shows a second situation of the memory system according to the fourth embodiment. The memory devices 210, 220 may receive a second data set 232 via their respective data ports 215, 225 and address ports 213, 223. The second data set 232 may comprise register values v00A through v06A to be stored in the registers at addresses R00 through R06 of the set of registers 219 of the first memory device 210, register values v00B through v06B to be stored in the registers at addresses R00 through R06 of the set of registers 229 of the second memory device 220, and a register value v07, as an example, to be stored in the registers at address R07 of both sets of registers 219, 229 of memory devices 210, 220.

According to this situation and embodiment, the register values v00B through v06B to be stored in the registers at addresses R00 through R06 of the set of registers 229 of the second memory device 220 are initially addressed to registers R08 through R14. However, the register value v152 is such that the memory devices 210, 220 store received data and register values in different registers, dependent on the value or signal being received from the input port 211, 221. Whereas the first memory device 210, receiving, for example, a low-level signal from the input port 211 in conjunction with the register value 152, writes the register values v00A through V06A addressed to R00 through R06 into registers R00 through R06 of the set of registers 219, the second memory device 220, receiving, for example, a high-level signal from the input port 221 in conjunction with the register value 152, writes the register values v00B through V06B addressed to R08 through R14 into registers R00 through R06 of the set of registers 229. This re-addressing may be effected by an addressing unit based on a decision, whether to use a received address or to alter, re-map, or re-address the received address. This decision may be provided by a logic unit according to an embodiment as they are described in conjunction with FIGS. 1A through, 1C, 3, Re-routing may be effected by means of increasing or decreasing, for example by means of adding or discounting a given address off-set, the received address, or a by means of re-mapping using a remapping table.

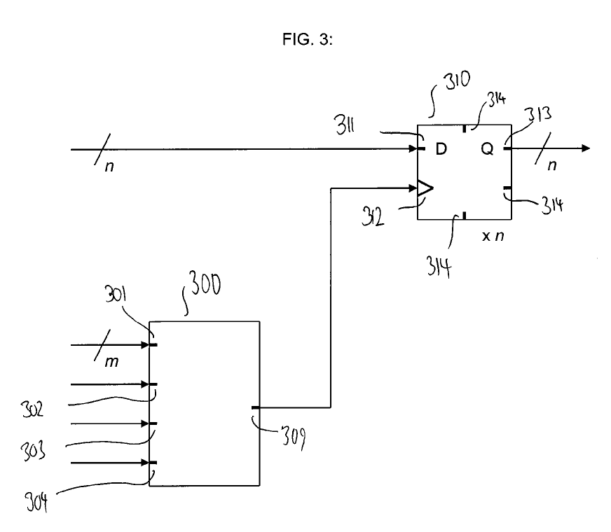

FIG. 3 shows a schematic view of a logic unit and a register according to a fifth embodiment. A register 310 comprises an input 311, an output 313 and a clock-input 312. The register 310 may be or comprise a flip-flop circuitry, in this case the first input 311 being equal to a D-input and the output 313 being equal to a Q-output. The memory device 310 may comprise further terminals 314, including, for example, an inverting output Q⁻¹, a set input S and/or a reset input R. As shown here, the register 310 is able to store 1 bit of information, being received from the input 311. For a word of n-bits the input and the output are provided with a width n and, accordingly, n registers 310 may be required, as indicated by /n and xn.

A logic unit 300 comprises a first input 301, a second input 302, a third input 303, and a fourth input 304. The logic unit 300 further comprises an output 309 being coupled to the clock-input 312 of the register 310. The register 310 only accepts and stores data from the first input 311 upon receiving an according signal at the clock-input 312. Acceptable signals may include a rising edge, a falling edge, a high level to low level transition, and/or a low level to high level transition. The logic unit 300 may consider the input from the first input 301, the second input 302, the third input 303, and the fourth input 304 to decide whether or not to drive the register 310 to accept incoming data.

The first input 301 of the logic unit 300 may be provided with a width m. In this way, for example, address data with the width m may be provided to the logic unit 300. The logic unit 300 may thus drive the register 310 to accept data only if received address data matches with corresponding predetermined address data. The second input 302 may receive a signal, such as a low level signal and/or a high level signal. This signal may be a mirror signal (MS), being provided to an integrated device, in order to, for example, determine whether the integrated memory device is to mirror connection terminals and/or is being mounted on a top side or on a bottom side of a circuit board. The third input 303 may receive a register value or a part of a register value being stored in a register. If the register value being stored in the register is being represented by a binary number, a part of the register value may be represented by one bit. This bit may be a bit of a mode register. Furthermore, additional signals may be received by the fourth input 304, such further signals including command signals and/or command data, such as an MRS command. In this way, the logic unit 300 is able to take all information being received from the inputs 301 through 304 into consideration and to decide whether or not the register 310 is to accept and store incoming data, and whether or not the register 310 is to driven accordingly.

As an example, an MF signal being provided to the second input 302 may indicate, that the integrated device is mounted on a first surface of a circuit board and being connected in parallel to a second integrated device, being mounted on an opposite second surface of the circuit board. The register value or a part of the register value being received at the third input 303 may indicate that data is to be accepted and written into a register 310, regardless of the state of the MF signal. A second value being received at the third input 303 may, in turn, be combined with other inputs in order to allow or not to allow a setting of the register 310.

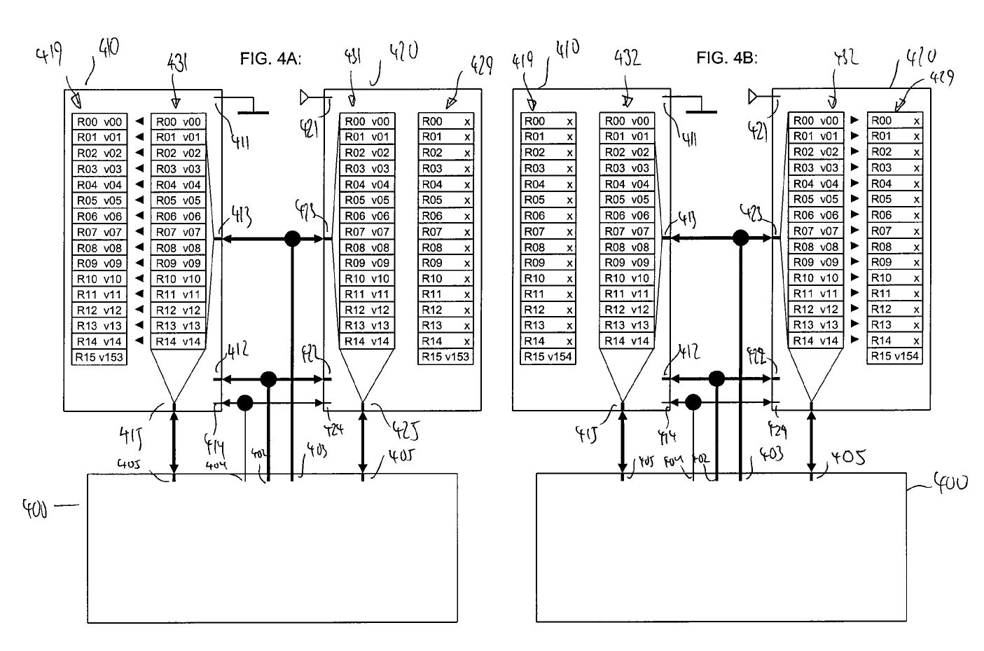

FIG. 4A and 4B show a memory system, according to a sixth embodiment. The memory system comprises a first memory device 410, a second memory device 420, and a controller 400. The memory devices 410, 420 may be, for example, DRAMs, GDRAMs, or GDDR DRAMs. The controller 400 may be, for example, a memory controller, a central processing unit, a microprocessor, or a graphics controller. The memory device 410 is connected via a data port 415 to a data port 405 of the controller 400. In a corresponding manner, the second memory device 420 is connected via a data port 425 to a data port 405 of the controller 400. A command port 412 of the first memory device 410 and a command port 422 of the second memory device 420 are connected in parallel to a command port 402 of the controller 400. An address port 413 of the first memory device 410 and an address port 423 of the second memory device 420 are connected in parallel to an address port 403 of the controller 400. In addition, a select port 414 of the first memory device 410 and a select port 424 of the second memory device 420 are connected in parallel to a select port 404 of the controller 400. Furthermore, the first memory device 410 comprises an input port 411, and the second memory device 420 comprises an input 421, for receiving a signal. The first memory device 410 comprises a set of registers 419, here, as an example, comprising registers R0 through R15. The second memory device 420 correspondingly comprises a set of registers 429, here, as an example, comprising registers R0 through R15. As far as the signals or data being provided to the input ports 411, 421 are concerned it referred to input ports 211, 221 as they have been described in conjunction with FIGS. 2A and 2B.

In the situation as shown in FIG. 4A, the registers R15 of both memory devices 410, 420 may store a third register value v153. The memory devices 410, 420 may receive a first data set 431 via their respective data ports 415, 425 and address ports 413, 423. The first data set 431 may comprise register values v00 through v14 to be stored in the registers at addresses R00 through R15 of the first memory device 410. According to this situation and embodiment, the register value 153 is such that only the first memory device 410 writes data vn addressed to Rn into the nth register Rn of the set of registers 419, n running from 00 through 14 here. The first memory device 410, receiving, for example, a low-level signal from the input port 411 in conjunction with the register value 153, writes the register values v00 through V14 addressed to R00 through R14 into registers R00 through R14 of the set of registers 419, the second memory device 420, receiving, for example, a high-level signal from the input port 421 in conjunction with the register value 153, does not write the register values vn into its registers Rn of the set of registers 429. The contents and register values stored in the registers of the set of registers 429 of the second memory device 420 ray remain unchanged.

Making the decision according to this situation may be effected by means of a logic unit according to an embodiment as they are described in conjunction with FIGS. 1A through, 1C, 3, or 5. Such a logic unit may consider, for making the decision, the register value or signal being received from the input port 411 and the register value 153 or a part thereof.

FIG. 2B shows a second situation of the memory system according to the sixth embodiment. In this situation, the registers R15 of both memory devices 410, 420 may store a fourth register value v154. The memory devices 410, 420 may receive a second data set 432 via their respective data ports 415, 425 and address ports 413, 423. The second data set 432 may comprise register values v00 through v14 to be stored in the registers at addresses R00 through R15 of the second memory device 420. According to this situation and embodiment, the register value 154 is such that only the second memory device 420 writes data vn addressed to Rn into the nth register Rn of the set of registers 429, n running from 00 through 14 here. The second memory device 420, receiving, for example, a high-level signal from the input port 421 in conjunction with the register value 154, writes the register values v00 through V14 addressed to R00 through R14 into registers R00 through R1 4 of the set of registers 429, the first memory device 410, receiving, for example, a low-level signal from the input port 411 in conjunction with the register value 154, does not write the register values vn into its registers Rn of the set of registers 419. The contents and register values stored in the registers of the set of registers 419 of the first memory device 410 ray remain unchanged.

According to this embodiment, the register values v00 through v14 of the first set of data 431 are to be stored in the registers at addresses R00 through R14 of the set of registers 419 of the first memory device 410, and the register values v00 through v14 of the second set of data 432 are to be stored in the registers at addresses R00 through R14 of the set of registers 429 of the second memory device 420. This may be effected by a writing of the third register value v153 and fourth register value 154, respectively, to both registers R15 of both sets of registers 419, 429. A controller, such as the controller 400, may then be relieved of remapping target addressing. This may have considerable benefits of a software or a program being run by the controller.

In conjunction with the situation as it has been described in line with FIG. 2A, a controller, such as the controller 200 or controller 400 may either write identical register values to registers of the two memory devices, possibly being effected simultaneously, dedicated register values to registers of the first memory device, or dedicated register values to registers of the second memory device. This may be effected by storing three different register values in a register, such as the register R15 which may be always accessible regardless of its register value and/or a signal from an input port 211, 221, 411, 421. Those three register values may include v151, v153, and v154, as they have been described in conjunction with FIGS. 2A, 4A, and 4B. The register, such as the register R15, being a binary register, may require at least two bits in order to distinguish the three

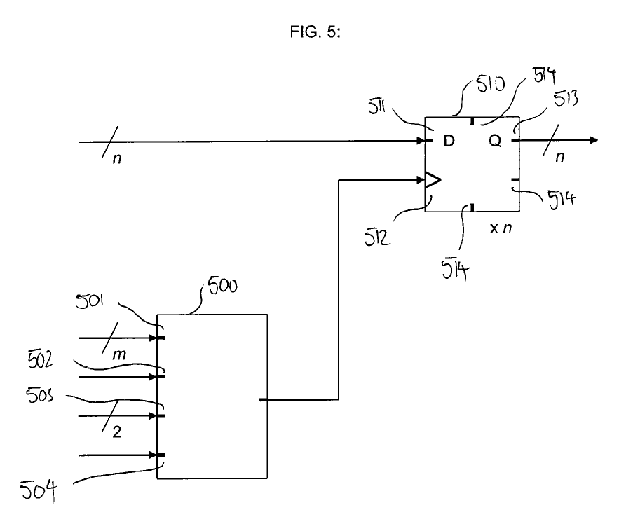

FIG. 5 shows a schematic view of a logic unit and a register according to a seventh embodiment. A register 510 comprises an input 511, an output 513 and a clock-input 512. As far as technical realization, a parallel setup, and/or the further terminals are concerned, it is referred to the description in conjunction with FIG. 3.

A logic unit 500 comprises a first input 501, a second input 502, a third input 503, and a fourth input 504. The logic unit 500 further comprises an output 509 being coupled to the clock-input 512 of the register 510. The register 510 only accepts and stores data from the first input 511 upon receiving an according signal at the clock-input 512. The logic unit 500 may consider the input from the first input 501, the second input 502, the third input 503, and the fourth input 504 to decide whether or not to drive the register 510 to accept incoming data.

According to this embodiment, the third input 503 of the logic unit 500 may provide a data bit width of at least 2, indicated by /2. In this way, the logic unit 500 may distinguish more than two situations, including the three situations as they have been described in conjunction with FIG. 2A, 4A, and 4B. A bit width of 2 may further allow a distinguishing of three different register values, such as the register values v151, v153, and v154. However, the register values v151, v152, v153, and v154 and the registers in which they are stored in may provide a bit-width greater than 2.

For further description of the first input 501, the second input 502, and the fourth input 504 of the logic unit 500 it is referred to the description of the first input 301, the second input 302, and the fourth input 304 of the logic unit 300, as it has been described in conjunction with FIG. 3.

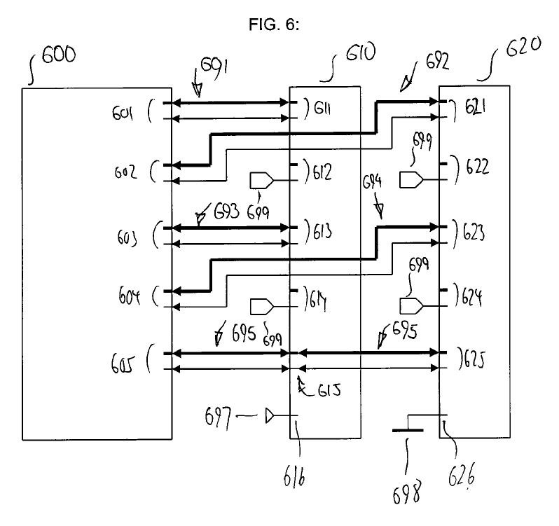

FIG. 6 shows a schematic view of a circuit system, according to an eighth embodiment. The circuit system comprises a controller 600, a first integrated device 610, and a second integrated device 620. The controller 600 comprises a first terminal 601, a second terminal 602, a third terminal 603, a fourth terminal 604, and a fifth terminal 605. The first integrated device 610 comprises a first terminal 611, a second terminal 612, a third terminal 613, a fourth terminal 614, and a fifth terminal 615. The second integrated device 620 comprises a first terminal 621, a second terminal 622, a third terminal 623, a fourth terminal 624, and a fifth terminal 625. A first bus 691 couples the first terminal 601 of the controller 600 to the first terminal 611 of the first integrated device 610. A second bus 692 couples the second terminal 602 of the controller 600 to the first terminal 621 of the first integrated device 620. In this way, a first set of data, such as a first byte of a word, may be exchanged with the first integrated device 610, and a second set of data, such as a second byte of the word, may be exchanged with the first integrated device 620. This may a allow a distribution of the word onto the two devices 610, 620, implying a reduction of a port width of the devices 610, 620. The distribution and/or reduction of a port width may be indicated by coupling the second port 612 of the first integrated device 610 and the second port 622 of the second integrated device 620, or parts thereof, to a respective signal, such as a control potential 699.

A fifth bus 695 may couple the fifth terminal 615 of the first integrated device 610 and the fifth terminal 625 of the second integrated circuit 620 in parallel to the fifth terminal 605 of the controller 600. The fifth bus 695 may comprise an address bus, a command bus, and/or a chip select signal (CS). The signals on the fifth bus 695 are provided to both integrated devices 610, 620 in parallel. In the case, the fifth bus 695 comprises a chip-select signal, both integrated devices 610, 620 are selected or deselected. Furthermore, the respective routing of such a CS-signal on a circuit board (PCB) may be, in this way, rendered less complicated.

According to this embodiment, the first integrated device 610 comprises a sixth terminal 616 and the second integrated device 620 comprises a sixth terminal 626. The sixth terminal 616 of the first integrated device 610 is coupled to a first signal, such as a first potential or a supply potential, whereas the sixth terminal 626 of the second integrated device 620 is coupled to a second signal, such as a second potential or a ground potential. In this way, although the integrated devices 610, 620 may be accessed in parallel, the integrated devices 310, 620 may still be able to distinguish themselves from a respective other integrated device. The integrated devices 610, 620, may further take into account a mode register value in combination with a value being received from the sixth inputs 616, 626, to decide whether or not to accept data being applied to both integrated devices 610, 620 in parallel, and/or to re-route or re-address data being applied to both integrated devices 610, 620 in parallel. This may be effected according to an embodiment as they have been described in conjunction with FIGS. 1A through, 1C, 2A and 2B, 3, 4A and 4B, and 5.

The circuit system may be part of a computer system, such as a main-board or graphics adapter, a memory system, or a memory module, such as a DIMM. The integrated devices 610 may comprise a memory device, such as a DRAM, a GDRAM, or a GDDR-DRAM. Furthermore, the controller 600 may be a memory controller, a graphics controller, a microcontroller, or a memory module controller.

The circuit system as shown in FIG. 6 may comprise more than two integrated devices, and may comprise more than one pair of two integrated devices. In such a way, for example, n pairs of memory devices may be cascaded in order to provide a given memory capacity.

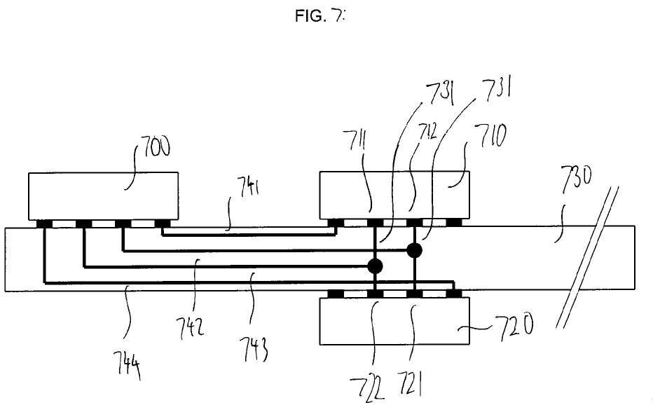

FIG. 7 shows a schematic view of a memory module according to a tenth embodiment. The memory module comprises a memory controller 700, a first memory device 710, a second memory device 720, and a circuit board 730. The first memory device 710 is mounted on a top surface of the printed circuit board 730 and the second memory device 720 is mounted on a bottom surface of the printed circuit board 730, facing each other. This may allow a simple connection of corresponding contact pads of the memory devices 710, 720, while avoiding signal line crossings. Vertical vias 751, being arranged perpendicular to a surface of the printed circuit board 730, may provide such connections. In such a case, a PCB routing may be simpler and/or avoid signal line crossings. Furthermore, the memory devices 710, 720 may be arranged in a so-called clamshell configuration and may allow a clamshell operation. The memory controller 700 may be connected to individual memory devices, such to the first memory device 710 via a first signal line 741 and to the second memory device 720 via a fourth signal line 744. The memory controller 700 may further be connected in parallel to both memory devices, the first memory device 710 and the second memory device 720, via a second signal line 742 and a third signal line 743.

In order to allow to connect a first contact terminal 711 of the first memory device 710 to a second contact terminal 722 of the second memory device 720, and to connect a second contact terminal 712 of the first memory device 710 to a first contact terminal 721 of the second memory device 720, by vertical vias 751, it may be necessary to reroute the internal connections of the contact terminals 711, 712, 721, and 722. In the arrangement as shown here, internal routing and rerouting within the memory devices 710 and 720 is such that the first contact terminal 711 of the first memory device 710 may be connected in parallel to the second contact terminal 722 of the second memory device 720. Similar routing and rerouting has taken place in order to connect the second contact terminal 712 of the first memory device 710 in parallel to the first contact terminal 721 of the second memory device 720.

According to this embodiment, the first memory device 710 may be instructed such that it is mounted on a top surface of the printed circuit board 730. Accordingly, the second memory device 720 is instructed such that it is mounted on a bottom surface of the printed circuit board 730. This instruction may be carried out by means of connecting dedicated control terminals to different potentials, such as to a ground potential and/or to a supply voltage potential. The re-routing itself may be effected by means of a mirroring or re-routing unit of the first memory device 710 and/or the second memory device 720.

The memory controller 700, according to this embodiment, may be still be able to address the memory devices individually, although they are connected in parallel to the memory controller 700 and/or are selected simultaneously, by means of a logic unit and/or an address unit as they have been described in conjunction with an embodiment.

The preceding description only describes advantageous exemplary embodiments. The features disclosed therein and the claims and the drawings can, therefore, be essential for the realization of the invention in its various embodiments, both individually and in any combination. While the foregoing is directed to the embodiments, other and further embodiments of may be devised without departing from the basic scope of the invention, the scope of the present invention being determined by the claims that follow.

What is claimed is:

1. A memory device, comprising:
a first port, the first port receiving a first register value and a second register value;
a second port, the second port receiving a third value;
a first register being coupled to the first port, the first register being set to the first register value;
a second register being coupled to the first port, the register having an enabled status and a disabled status, the register being set to the second register value in the enabled status, the second register remaining unchanged in the disabled status; and
a logic unit being coupled to the second port, to the first register and to the second register, the logic unit setting the status of the second register to the enabled status or the disabled status dependent on the first register value stored in the first register and the third value applied to the second port.

2. The memory device as claimed in claim 1, further comprising
a third register being coupled to the first port;
an address port receiving address data; and
an addressing unit being coupled to the address port, to the logic unit, to the second register and to the third register, the addressing unit addressing the third register to be set to the second register value in case an address data of the second register is applied to the address port and the status of the second register is set to the disable status by the logic unit.

3. The memory device as claimed in claim 1, wherein the first register and the second register are mode registers, the mode registers setting an operation mode of the memory device.

4. The memory device as claimed in claim 1, further comprising a terminal array and a mirroring unit, the terminal array comprising contact terminals and being coupled to the first port and to the second port, the mirroring unit being coupled to the second port and mirroring the contact terminals of the terminal array in respect to a mirroring axis dependent on the third value

5. The memory device as claimed in claim 1, wherein the memory device is a DRAM device.

6. The memory device as claimed in claim 1, wherein the third value is preset.

7. The memory device as claimed in claim 6, wherein the third value is preset by a hard-wired connection to the second port.

8. A memory device, comprising:
a first port, the first port receiving a first register value and a second register value;
a second port, the second port receiving a third value;
an address port receiving address data;
a first register being coupled to the first port, the first register being set to the first register value;
a second register being coupled to the first port;
a third register being coupled to the first port;
a logic unit being coupled to the second port and to the first register, the logic unit setting a register status; and
an addressing unit being coupled to the address port, to the logic unit, to the second register and to the third register, the addressing unit addressing the third register to be set to the second register value dependent on an address data being applied to the address port and the register status being set by the logic unit.

9. The memory device as claimed in claim 8, wherein the register status is either an enabled status or a disabled status of the second register, the addressing unit addressing the second register to be set to the second register value in case an address data of the second register is applied to the address port and the status of the second register is set to the enable status by the logic unit, the addressing unit addressing the third register to be set to the second register value in case an address data of the second register is applied to the address port and the status of the second register is set to the disable status by the logic unit.

10. The memory device as claimed in claim 8, wherein the first register, the second register and the third register are mode registers, the mode registers setting an operation mode of the memory device.

11. The memory device as claimed in claim 8, further comprising a terminal array and a mirroring unit, the terminal array comprising contact terminals and being coupled to the first port and to the second port, the mirroring unit being coupled to the second port and mirroring the contact terminals of the terminal array in respect to a mirroring axis dependent on the third value.

12. The memory device as claimed in claim 8, wherein the memory device is a DRAM device.

13. The memory device as claimed in claim 8, wherein the third value is preset.

14. The memory device as claimed in claim 13, wherein the third value is preset by a hard-wired connection to the second port.

15. A method of operating an integrated device, the integrated device comprising a first register, a second register and an input, the method comprising:
storing a first register value in the first register;
applying a signal to the port;
setting a status of the second register to an enabled status or a disabled status dependent on the first register value stored in the first register and the signal applied to the input; and
storing a second register value in the second register in case the enabled status is set.

16. The method as claimed in claim 15, wherein the status of the second register is selected dependent on a level of the signal applied to the input.

17. The method as claimed in claim 15, wherein the first register value is represented by at least two bits, the status of the second register is selected dependent on one of the at least two bits.

18. The method as claimed in claim 15, wherein the first register value is represented by at least three bits, the status of the second register is selected dependent on two of the at least three bits.

19. The method as claimed in claim 15, wherein the integrated device further comprises a third register and an address input, the method further comprising:
storing the second value in the third register in case an address data of the second register is applied to the address input and the status of the second register is set to the disable status.

20. The method as claimed in claim 19, further comprising:
receiving of an address data of the second register; and
changing the address data of the second register to an address data of the third register in case the status of the second register is set to the disable status.

21. The method as claimed in claim 15, wherein the first register and the second register are mode registers, the mode registers setting an operation mode of the integrated device.

22. The method as claimed in claim 15, wherein the integrated device further comprises a terminal array with contact terminals and a mirroring unit, the mirroring unit mirroring the contact terminals of the terminal array in respect to a mirroring axis dependent on the signal applied to the input.

23. The method as claimed in claim 15, wherein the signal applied to the input is preset.

24. The method as claimed in claim 15, wherein the signal is preset by a hard-wired connection to the input.

25. A circuit system comprising a controller, a first integrated device and a second integrated device, each integrated device comprising:
a first port being coupled to the controller and receiving a first register value and a second register value;
a second port, the second port receiving a third value;
a first register being coupled to the first port, the first register being set to the first register value;
a second register being coupled to the first port, the register having an enabled status and a disabled status, the register being set to the second register value in the enabled status, the second register remaining unchanged in the disabled status; and
a logic unit being coupled to the second port, to the first register and to the second register, the logic unit setting the status of the second register to the enabled status or the disabled status dependent on the first register value stored in the first register and the third value applied to the second port.

26. The circuit system as claimed in claim 25, each integrated device further comprising:
a third register being coupled to the first port;
an address port being coupled to the controller and receiving address data; and
an addressing unit being coupled to the address port, to the logic unit, to the second register and to the third register, the addressing unit addressing the third register to be set to the second register value in case an address data of the second register is applied to the address port and the status of the second register is set to the disable status by the logic unit.

27. The circuit system as claimed in claim 25, each integrated device further comprising a command port being coupled to the controller and receiving command data, the logic unit being coupled to the command port and setting the status of the second register dependent on the command data applied to the command port.

28. The circuit system as claimed in claim 25, wherein the first register and the second register are mode registers, the mode registers setting an operation mode of the integrated device.

29. The circuit system as claimed in claim 25, wherein the third register is a mode register, the mode register setting an operation mode of the integrated device.

30. The circuit system as claimed in claim 25, wherein one of the first integrated device and the second integrated device further comprises a mirroring unit, the mirroring unit being coupled to the second port and mirroring contact terminals of the integrated device in respect to a mirroring axis dependent on the third value.

31. The circuit system as claimed in claim 25, wherein the first integrated device and the second integrated device are DRAM devices.

32. The circuit system as claimed in claim 25, wherein the third value is preset.

33. The circuit system as claimed in claim 25, wherein the third value is preset by a hard-wired connection to the second port the respective integrated device.

34. An integrated device, comprising:
means for storing a first register value;
first means for storing a second register value in case an enabled status is set;
means for receiving a signal; and
means for setting the enabled status or a disabled status of the first means for storing the second register value dependent on the first register value and the signal.

35. The integrated device as claimed in claim 34, wherein the enabled status is selected dependent on a level of the signal.

36. The integrated device as claimed in claim 34, wherein the first register value is represented by at least two bits, the enabled status being dependent on one of the at least two bits.

37. The integrated device as claimed in claim 34, wherein the first register value is represented by at least three bits, the enabled status being dependent on two of the at least three bits.

38. The integrated device as claimed in claim 34, further comprising:
second means for storing the second register value; and
means for receiving address data, the second register value being stored in the second means for storing the second register value in case address data of the first means for storing the second register value is received and the disabled status is set.

39. The integrated device as claimed in claim 38, further comprising:
means for changing received address data of the first means for storing the second register value to an address data of the second means for storing the second register value in case the disabled status is set.

40. The integrated device as claimed in claim 38, wherein the first and second means for storing the second register value are mode registers, the mode registers setting an operation mode of the integrated device.

41. The integrated device as claimed in claim 34, further comprising:
means for connecting signals to the integrated device; and
means for mirroring said means for connecting signals to the integrated device in respect to a mirroring axis and dependent on the signal.

42. The integrated device as claimed in claim 34, wherein the means of receiving the signal are preset.

43. The integrated device as claimed in claim 42, wherein the means of receiving the signal are preset by a hard-wired connection.
